(19) United States
(12) Patent Application Publication
(10) Pub. No.: US 2009/0245500 A1
(43) Pub. Date: Oct. 1, 2009

(54) ARTIFICIAL INTELLIGENCE ASSISTED LIVE AGENT CHAT SYSTEM

(76) Inventor: Christopher Wampler, Agoura Hills, CA (US)

Correspondence Address: Arent Fox LLP, 555 West Fifth Street, 48th Floor, Los Angeles, CA, 90013, US

(21) Appl. No.: 12/055,596

(22) Filed: Mar. 26, 2008

(51) Int. Cl. H04M 3/00

(52) U.S. Cl. 379/265.09

(57) ABSTRACT

An artificial intelligence (AI)-assisted live agent chat system allows a single live agent to handle an increased number of simultaneous chat sessions by having an AI system handle the bulk of common, repeat questions. The AI system will allow the live agent to focus his or her attention on the few chat sessions needing unique service and will effectively lower the cost of supporting chat sessions. The server-side technology uses an AI-engine as ell as a live agent backend interface for a site to deliver live-agent experience without the customer having to know whether the answer is from the AI system or from the live agent.

### BACKGROUND

1. Field

The present disclosed embodiments relate to an automated messaging system and, more particularly to an artificial intelligence assisted live agent chat system.

2. Background

In order to provide proper customer support and service, companies typically expend a large amount of funds to establish and support telephone call centers. To minimize customers being placed on hold when they call companies for support or service, call centers must be staffed with a sufficient number of customer support representatives (also referred to as agents), because each of them can normally only handle a single telephone call at a time.

Technical solutions such as online chat and instant messaging systems provide a less costly alternative to telephone call centers because a customer support representative may be able to handle multiple conversations (“chats” or “chat sessions”). However, the staffing of agents for backend operations centers required to implement live online chat applications can still be very expensive. Consequently, even though an average agent is now able to handle a few chat sessions simultaneously this solution may still remain fairly expensive.

Also, many times a large percentage of the customer queries are similar, if not identical to each other. Using a live agent to repeatedly read and respond to the same set of frequently asked questions is an inefficient use of an agent's time and the center's capacity.

### SUMMARY

The following presents a simplified summary of one or more aspects in order to provide a basic understanding of such aspects. This summary is not an extensive overviews of all contemplated aspects, and is intended to neither identify key or critical elements of all aspects nor delineate the scope of an, or all aspects. Its sole purpose is to present some concepts of one or more aspects in a simplified form as a prelude to the more detailed description that is presented later.

According to an aspect a method is disclosed for assisting a live agent in interacting with customer inquiries through a network chat messaging system for a website that includes detecting a customer interaction with the website, determining whether an automated response system is enabled to respond to the customer interaction, the automated response system being capable of interacting with the customer through the network chat messaging system using an artificial intelligence (AI) system; and, notifying the live agent regarding the customer interaction upon determining the automated response system is disabled.

According to another aspect, a computer interface is disclosed for a live agent to interact with a plurality of customers through a network chat messaging system having an artificial intelligence (AI) system for interacting with each customer in the plurality of customers that includes a list of live chat sessions being monitored by the live agent, the list comprising a chat session status indicator; and a chat session interface for monitoring the AI system and interacting with at least one customer in the plurality of customers. The chat session interface also includes a live agent message input field: a live agent message display; and an AI system proposed response display for displaying proposed responses generated by the AI system.

According to another aspect, a computer program product for assisting a live agent in interacting with customer inquiries through a network chat messaging system for a website is disclosed. The computer program product includes a computer readable medium having codes executable to detect a customer interaction with the website; determine whether an automated response system is enabled to respond to the customer interaction, the automated response system being capable of interacting with the customer through the network chat messaging system using an artificial intelligence (AI) system; and, notify the live agent regarding the customer interaction upon determining the automated response system is disabled.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed aid the described aspects are intended to include all such aspects and their equivalents.

### BRIEF DESCRIPTION OF THE DRAWINGS

FIG. 1 is a system diagram illustrating a network of computer systems, configured in accordance with one approach of an artificial intelligence (AI) assisted live agent chat system.

FIG. 2 is a flow diagram illustrating an exemplary operation of the AI-assisted live agent chat system that can support interactions between a live agent and one or more customers.

FIG. 3 is a sample screen capture of a graphics user interface (GUI) implemented by a web page of a website's customer service section showing a chat window usable for a customer to interact with a chat system such as the AI-assisted live agent chat system of FIG. 1.

FIG. 4 is a sample screen capture of a GUI of an agent interface illustrating the capabilities provided to a live agent for monitoring multiple chat sessions, enabling or disabling the AI system, repooling one or more chat sessions, pushing scripted lines generated by the AI-assisted live agent chat system ending chat sessions, and transferring chat sessions to a different live agent.

FIG. 5 is a sample screen capture of the agent interface of FIG. 4 illustrating an alert generated by the AI-assisted live agent chat system to the live agent that intervention by the live agent is needed.

FIG. 6 is a block diagram of a computer system usable in the AI-assisted live agent chat system of FIG. 1.

### DETAILED DESCRIPTION

The word “exemplary” is used herein to mean “serving as an example, instance, or illustration.” An, embodiment described herein as “exemplary” is not necessarily to be construed as preferred or advantageous over other embodiments.

Using an artificial intelligence (AI) system on the server-side of the live-agent interface, mane, of the frequently asked questions from customers may be answered without ever requiring the involvement of a live (i.e., human) agent. The AI system is used as part of an AI-assisted live agent chat system to assist live agents for handling customer inquiries. When the AI system cannot find a suitable response, a live agent can manually interact with the customer. The questions and responses are stored in a knowledge database accessible by the AI system. Specifically, depending on the type of website and profile of the customer base, a certain percentage of the questions normally presented to the live chat agent will be similar. These questions can be matched to a scripted natural language regular expression (search expression) on the server side. A response can be retrieved from a search of the knowledge database and then presented.

For example, for an e-commerce customer support system common responses answering questions about pricing, shipping, return policy and payment types, along with one or more matching search expressions, would be programmed into the knowledge database used by the AI system to implement the AI-assisted live agent chat system. Each time one of the questions is posed by the customer, the AI system can provide a response to the question, allowing the live agent to focus on more intricate or detailed questions from other customers.

In addition to the filtering of and responding to individual customer questions, the AI system has the ability to alert the live agent of chat sessions that need attention and can automatically enable a response based on keywords, or whether an answer is found. The live agent also has the ability to monitor ongoing AI-supported chat sessions and intercede at the live agent's choosing. The live agent can then allow the AI system to respond automatically when the agent feels the difficult part of the interaction with the customer has been handled.

The live agent is able to both type responses to the customer in addition to pushing pre-scripted responses that are automatically presented to the live agent by the AI system to the customer. These pre-scripted responses result from searches of the knowledge database by the AI system for the live agent and can supplement the live agent responses.

Other features include the ability to re-pool chat sessions into the chat system that are no longer chatting and/or needing monitoring, the ability to transfer chat sessions to other live agents (either with the AI system on or off) and the ability to manually end chat sessions if the live agent feels the conversation has been completed.

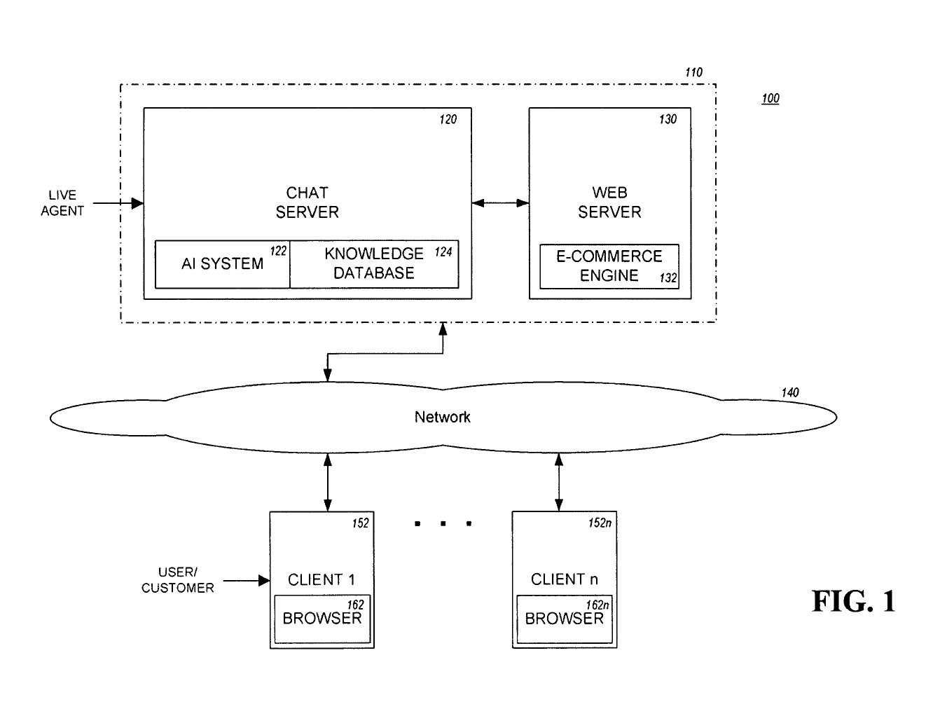

FIG. 1 illustrates a system diagram 100 in which an AI-assisted live agent chat system may be implemented in accordance with one aspect of the present disclosure, including a server system 110 having a chat server 120 for hosting an AI system 122 and a knowledge database 124, and a web server 130 having an e-commerce engine 132. A plurality of clients 152-152n are coupled for communicating with the server system 110 through a network 140. As described herein, a user, using software on a client computer such as a browser 162 on the client 152, interacts with the server system 110. Multiple server systems and clients, as well as other computer systems (not shown may also be coupled to the server system 110. Also, the e-commerce engine 132 interacts with other application software on the web server 130 and the chat server 120 to perform the AI-assisted live agent chat system functionality as described herein, including receiving requests for Web pages from one or more client computers, generating and transmitting the necessary information for rendering the web pages on client computers (along with the client-side code that is deployed to manage chat windows), and receiving the results therefrom. The e-commerce engine 132 may access and present information from, as % ell as store information into, an e-commerce database (not shown). In certain applications where there is no e-commerce engine, the web pages containing the client-side code deployed to trigger the chat window may be provided directly by the web server 130. Further, although the server system 110 is presented as two servers; with the web server 130 being hosted by one entity, and the chat server 120 including the AI system 122 being hosted by yet another entity, the AI-assisted live agent chat system functionality provided herein may be deployed using a single server or may be spread over multiple systems.

As described herein, the user may interact with the information stored in server system 110 through browser software. The browser presents a graphical user interface (GUI) to the user. In the following description, the GUI is implemented using one or more web pages (which may be referred to as “pages,” “screens,” or “forms”) provided by the web server 130 accessible by the user using any Internet web browser software, such as the Internet Explorer™ browser provided by Microsoft Corp., on a client computer such as the client 152. In another embodiment, one or more custom software programs can be created to implement the system described herein. Of course, the web server 130 may itself have browser software installed on it so as to be accessed by a user. Further, throughout the description of the various embodiments of the invention herein, references are made to the user performing such actions as selecting buttons inputting information on forms, executing searches or updates. In one approach, these actions are generated by the user during the user's interaction with the browser. For example, one or more pages described herein are electronic forms (e.g., chat windows) that include fields in which the user may type. Once the user has provided such data, the user may select a button or link on the page to submit the information (e.g., a message) and cause an update of the chat server 120 with the information. For example, the browser will send the web server 130 the information retrieved from the user using the electronic form, which will cause the chat server 120 to be updated.

In the illustrated embodiment, the network 140 represents a variety of networks that may include one or more local area networks as well as wide area networks. The functionality provided by the chat server 120, the web server 130, the plurality of clients 152-152n, as well as by any other computer systems necessary in the AI-assisted live agent chat system may be implemented using a computer system having the characteristics of the computer system described further herein. It should be noted, however, that the specific implementation of the computer system or systems used to describe the present system is not to be limiting unless otherwise specifically noted. For example, the functionality provided by the chat server 120 and the web server 130 may be combined in one computer system. Further, the functionality provided by the chat server 120 and the web server 130 may be distributed over several computer systems.

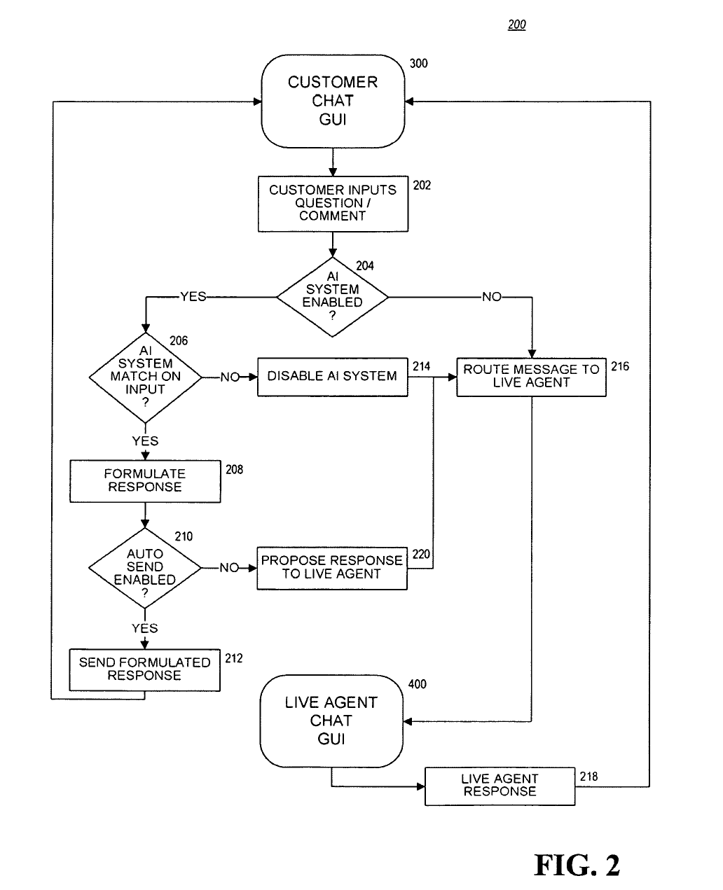

The following description is an exemplary operation of the AI-assisted live agent chat system where a customer, using the browser 162 on the client 152, interacts with the AI-assisted live agent chat system implemented using the server system 110. In one aspect; the interaction between the customer and the AI-assisted live agent chat system comprises a series of transmitted statements or questions, with one or more messages being provided by the AI-assisted live agent chat system. The customer may also be queried for more information by a the live agent or the AI system 122. Each message sent from the client-side software (e.g., the browser 162) to the server application will be serviced by the server system 110 (e.g., the chat server 120), in accordance with the process as illustrated in FIG. 2.

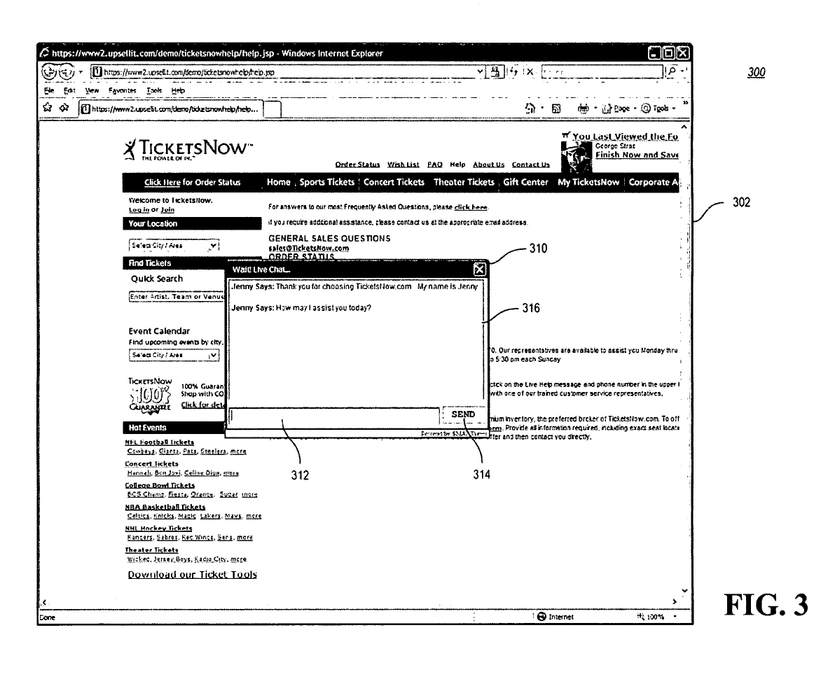

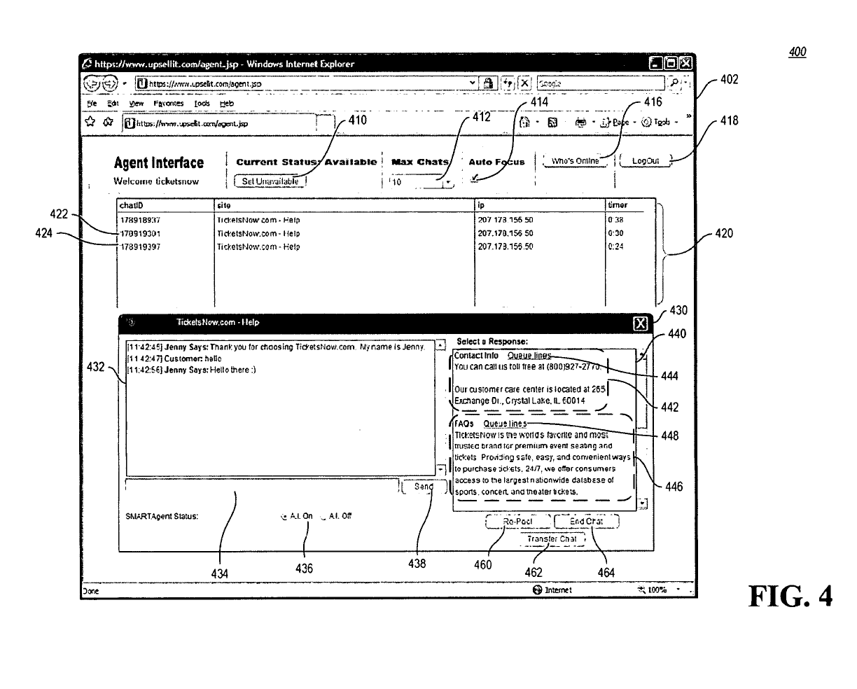

FIG. 2 illustrates au exemplary process 200 of the operation of the AI-assisted live agent chat system for supporting an interaction (e.g., a chat session) between a customer on a website hosted on the web server 130 and a live agent on the backend, with the AI system 122 of the chat server 120 handling a set of commonly asked questions and the live-agent being requested to interact with the customer when the AI system 122 is not able to address the message sent by the customer. The interaction between the customer, the AI system 122 and live agent occurs through the use by the customer of a chat window located in a web page, which is further described with reference to a screen capture 300 in FIG. 3 of a customer chat GUI presented to the customer as veil as through the use by the live agent of an agent control panel located in a web page, which is further described with reference to a screen capture 400 in FIG. 4 of an agent interface GUI presented to a live agent.

Beginning with step 202, the customer enters text into a text entry box 312 of a chat window 310 in a web page 302. The chat window 310 is the customer's view into, and interface for, the chat session. The customer is able to enter text and press a “send” button 314 or hit “enter” to deliver the text to the AI-assisted live agent chat system. Responses from the AI-assisted live agent chat system are displayed in the customer chat window 310 in a customer message display 316. In one aspect, the functionality of the customer chat window 310 is implemented through a client-side script that runs on a client such as the client 152. In addition, the chat session that is displayed in the customer chat window 310, as triggered by the web pages transmitted to the client 152 by the web server 130, is hosted by the chat server 120. Thus, as described herein, the live agent and the AI system 122 interacts with the customer through the chat server 120 which itself reaches the customer through the browser 162 on the client 152 to implement the client-side customer experience.

Once a message has been received from the customer, the AI-assisted live agent chat system will prepare a response. In one aspect, the AI-assisted live agent chat system is able to operate in three modes to respond to the chat messages sent from the customer: (1) a fully automated chat mode, without intervention from the live agent (unless an AI disabling event occurs); (2) a fully live agent-based mode, where the live agent is fully engaged in the chat session without input from the AI system 122; or (3) a mixed mode where the AI system 122 provides proposed responses to the live agent, but the live agent is the one that controls the transmission of the chat message to the customer.

Based on whether the AI system 122 is enabled or disabled, as determined in step 204, the chat message is either routed directly to the live-agent for handling in step 212, or the AI system 122 will attempt to find an appropriate response in step 206, respectively. Assuming it is determined that the AI system 122 is not disabled for this chat session in step 204 the AI system 122 will attempt to find a match for the text sent by the customer in step 206.

In one approach, the AI system 122 is an automated response chat system implemented using artificial intelligence. The AI system 122 is able to interact with customers through a plurality of predefined rules and keywords. Specifically, the AI system 122 provides responses based on an analysis of the messages that the customer sends using responses stored in the knowledge database 124. The analysis is performed using on keywords and rule matches. The list of keywords and rules are configured according to a customer support campaign. In addition to the preprogrammed keywords and rules, the AI system 122 may augment its responses by detecting whether and even how the customer has interacted with the AI-assisted live agent chat system to determine what responses may be provided to the customer.

For example, the AI system 122 may detect how the customer has interacted with e-commerce engine 132 and the web server 130 to attempt to ascertain what issues the customer may have with the web site. Thus, if the customer abandoned an e-commerce transaction during a check-out process, the AI system 122 may engage the customer to offer the customer a discount on shipping. In contrast, if the customer abandoned the e-commerce transaction during a review of a product, the AI system 122 may offer the customer a discount on the product or other incentive (including, again, discounted shipping). In another example, where the customer has, or is about to complete the e-commerce transaction, what the customer has purchased during the e-commerce transaction may affect the operation of the AI system 122 so that the AI system 122 agent may offer additional services (e.g., offering professional installation if the customer has purchased a wall-mountable flat-screen television set) or products (e.g., offering cables or other accessories for the television set).

Although the examples above are specific to e-commerce transactions such as online shopping, the scope of how the AI-assisted live agent chat system is not limited to these examples or, as certain provided examples have detailed, even limited to the “recapture” of customer interactions. Thus, for example, the term “e-commerce” as applied in the description contained herein should be applied broadly as to an, interaction with a customer, whether that interaction is related to the purchasing of a product or service or a filling out of a form for information gathering purposes. The specific information, promotion or marketing response implemented by the AI system 122 may be customized as needed.

Moreover, in addition to generating messages based on an analysis of the customer's action, the AI system 122 can also generate messages based on an analysis of the live agent's messages, and, in general, the interaction between the customer and the live agent.

If a matching response is found in step 206, then an appropriate response is formulated in step 208. In one aspect, if the AI-assisted live agent chat system is in the fully automated chat mode, as determined in step 210, then the AI system 122 is allowed to send the formulated response automatically to the customer in step 212. In this mode, the AI system 122 will send the response without any need for live agent intervention.

In one aspect, an unrecognized customer input will disable the AI system 122. Further, the AI system 122 is also configured to detect a match of keywords or rules on the customer's input that will trigger the automatic disabling or the AI system 122. Thus, where either: (1) the AI system 122 has not found a match to provide a proposed response, or (2) the AI system 122 has found a keyword or rule match that is purposefully designated to disable the AI system 122—both or which are referred to as AI system disabling events—in one aspect the automated response feature of the AI system 122 will be disabled automatically in step 214. Further, the AI system 122 can be manually disabled by the live agent for one or more chat session.

Referring to FIG. 4, an agent interface window 402 illustrates a list of currently live chat sessions 420 that is assigned to the live agent. Each chat session is assigned with a chat identifier number (“chatID”), a source from which the chat session was initiated (“site”), an IP of the client associated with the chat session (“ip”), and a timer tracking the amount of time since the last activity in the chat session (“timer”). Chat sessions that are being handled successfully by the AI system 122, such as a chat session 424 with a ChatID “178919397”, are displayed in the list as entries with white backgrounds. The live agent may: select a chat session, such as a chat session 424 with a ChatID “178919301”, to monitor the interaction between the customer and the AI system 122 using a live agent chat window 430. The selected chat session 424 is indicated in the list of currently live chat sessions 420 by a hi-lighted entry.

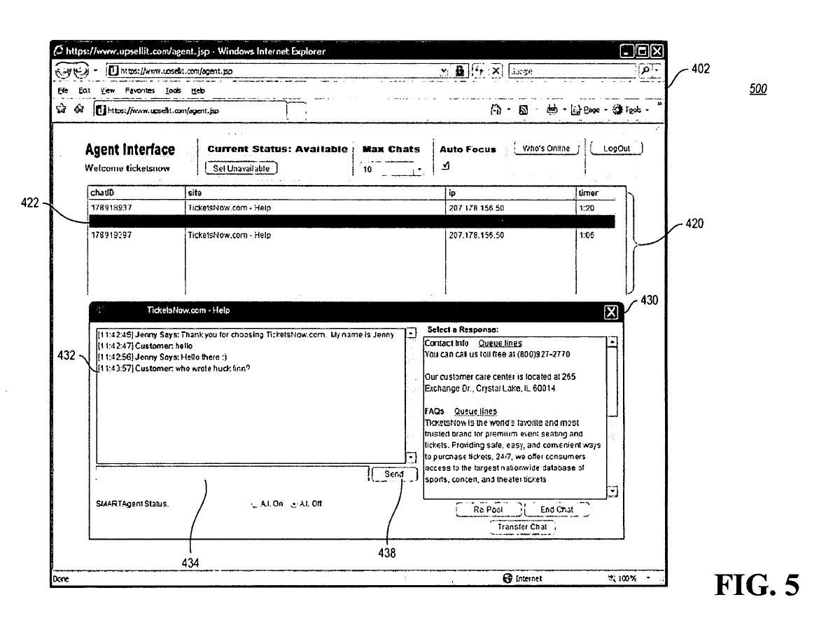

In step 216, the message from the customer will be routed to the live agent assigned to the chat session along with an alert notifying the live agent that this particular chat session requires manual intervention. Thus, in the event there is a detection of either: (1) an AI system disabling event such as a customer text input that disables the AI system 122, or (2) a customer input on a chat session where the AI system 122 has been disabled by the live agent, the live agent is alerted through a red background for the chat session 422 in the list of currently live chat sessions 420, as illustrated in a screen capture 500 of FIG. 5. In one aspect, the live agent may also be alerted by a sound or by bringing the chat window associated with the chat session (e.g., the agent chat window 430) to focus in the live agent interface window 402.

In step 218 the live agent may prepare and send a message to the customer in a variety of manners if the AI system 122 is disabled from sending automatic responses to the customer. Referring again to FIG. 4, in one aspect the live agent can create a message to the customer by entering text into a text entry box 434 directly without the assistance from the AI system 122. The live agent may also insert additional text into the message to be sent to the customer by copying and pasting text from other windows, such as a search window (not shown) used by the search agent to search the knowledgebase 124 for additional information, or any other windows (not shown) displayed to the live agent.

If, as determined in step 210, the AI system 122 is enabled to generated proposed messages but is disabled from automatically sending a response to the customer, then the AI system 122 will present the one or more responses generated in step 208 to the live agent in step 220 as the message is routed to the live agent in step 216. As discussed herein, the AI system 122 can generate proposed messages or responses based on an analysis of the customer's messages or interactions between the customer and the AI-assisted live agent chat system. The analysis may include an analysis of the customer's interaction with the web server 130 as tell as the information stored about the customer. For example, it may be that the customer has a history of shipping using methods that allow tracking. Thus, if the AI-assisted live agent chat system is engaged to respond to the customer based on a question from the customer about shipping or order status, then the AI system 122 can use this information to propose a list of responses having to do with the status or shipment of the order. Any proposed responses are listed in a proposed message panel 440 in the live agent chat window 430. The live agent is able to use the text that is listed in the proposed message panel 440 by selecting a “Queue lines” link displayed next to each proposed message such as links 440 and 448 for proposed messages 442 and 446, respectively. In one aspect, one or more proposed messages may be queued by the live agent to be sent to the customer: with or without additional editing or typing by the live agent. In another aspect, the AI-assisted live agent chat system will automatically send the proposed message associated with the link that is selected by the live agent without the live agent having to press the “Enter” key or selecting the “Send” button 438.

Once a message has been generated by the live agent—either with or without the use of the proposed responses from the AI system 122—the live agent can send the message either by pressing the “Enter” key on a keyboard or clicking on a “Send” button 438. In one aspect the text that is in the text entry box 434 is first sent to the chat server 120 which in turn sends it to the client 152 to be displayed on the customer message displays 316 in the customer chat window 310. In another aspect, the client 152 may be sent the message directly without the use of the chat server 120. The message is also displayed in a live agent message display 432.

In one aspect, the messages sent to the customer, whether they are generated by, the AI system 122, typed by the live agent, or created from a combination of the two, are presented in the customer chat window 310 without differentiation. In other words, both the AI system 122 generated and live agent created answers are displayed the same way to the customer, with no indication of how the answer was generated. Thus, the customer should not be able to detect how the responses the customer receives are generated. However, the messages sent by the backend system (e.g., the live agent or the AI system 122) will be displayed differently from the customer to allow the customer to visually differentiate the messages.

In one aspect, the AI-assisted live agent chat system tracks details of the text in the live agent message display 432 in the live agent chat window 430 so that the presentation of the text is based on whether the text was generated by the AI system 122 or the live agent (e.g., by the live agent typing the text). This allows the live agent (or another entity such as a supervisor, a person debugging the system, or a person improving the matching script) to determine how the text in the messages sent to the customer as generated. For example, any text typed or pasted into the window by the live agent may be colored in blue, while any text generated by the AI system 122 may be colored in green, in addition to any other color that may be assigned to the customer to differentiate the text from each other. Thus, how well the AI system 122 is operating, at least with respect to the successfulness of its response rate can be determined by someone looking at the color of the text in the live agent message display 432. Further, the log may be analyzed by the AI system 122 to continually update the knowledge database 124 automatically with updated or new responses.

As detailed in FIG. 4, other features provided in the live agent interface window 402 to the live agent includes the ability to set a status of the live agent to being available or unavailable with an availability toggle 410. The live agent is also able to set a maximum number of chat sessions the live agent wishes to have displayed in the list of currently live chat sessions 420 at one time using a “Max Chats” setting 412 in the live agent interface window 402. An “Auto Focus” checkbox 414 will bring the window for the chat session that has last received a message to be brought to into focus and brought in front of other windows. A “Who's Online” button 416 will indicate who is online, while a “LogOut” button 418 will allow the live agent to logout of the system Further, in addition to the ability offered to the live agent of being able to type responses in the text entry box 434, the live agent chat window 430 also provides the live agent the ability to perform: a re-pooling of a chat session by which a currently idle chat is sent back into the system but not closed, through the use of a “Re-Pool” button 460; a transferring of a chat session from the current live agent to another live agent through the use of a “Transfer Chat” button 462; and a manual termination of the chat session on both the live agent and customer's side through the use of an “End Chat” button 464.

Also, although the automated chat interaction process is repeated ever) time a customer enters text into the chat window, as discussed herein, the live chat agent can intercede at any point in the conversation by using the live agent interface window 402 to override the AI system 122 and manually entering (e.g. typing) text to be displayed to the customer. In one aspect, through the live agent interface window 402, the live agent has the ability to both enable/disable the AI system 122 for a particular chat session using an AI system toggle 436 in the live agent chat window 430. Specifically, the live agent can manually disable the AI system 122 through the use of the radio button “AI Off” in the AI system toggle 436. Once the AI system 122 has been disabled, the live agent can interact with the customer in the chat session and then simply re-enable the AI system 122 using the radio button “AI On” in the AI system toggle 436 if the chat session requires no further manual attention. In one aspect, the AI system 122 may continue to generate one or more proposed responses based on the interaction between the customer and the live agent whether or not the AI system 122 has been enabled.

It should be noted that chat sessions may be initiated through a variety of events, including a detection of a chat session request by the customer, an event by the customer interacting with the system, or a request from the live agent. Thus, chat sessions are not necessarily only started by a customer.

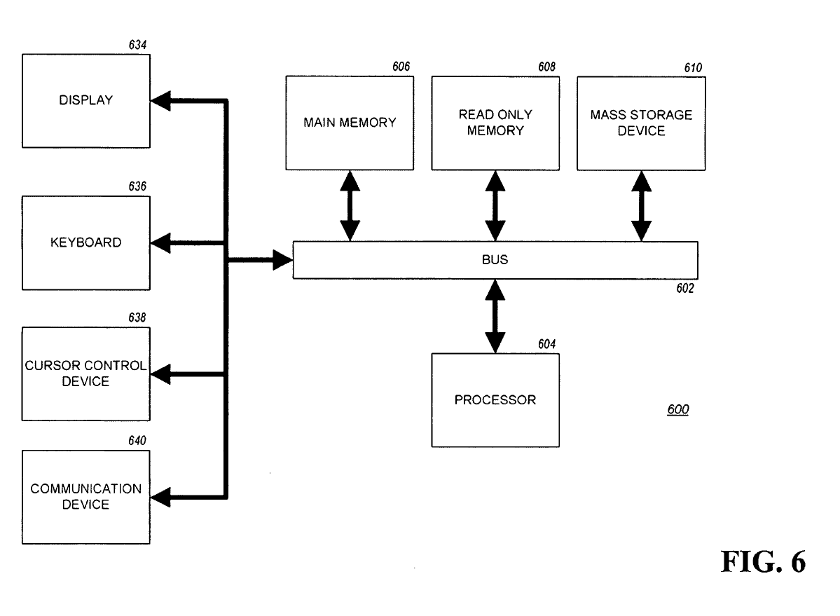

FIG. 6 illustrates an example of a computer system 600 in which the features of the present invention may be implemented. Computer system 600 includes a bus 602 for communicating information between the components in computer system 600, and a processor 604 coupled with bus 602 for executing software code, or instructions, and processing information. Computer system 600 further comprises a main memory 606, which may be implemented using random access memory (RAM) and/or other random memory storage device coupled to bus 602 for storing information and instructions to be executed by processor 604. Main memory 606 also may be used for storing temporary variables or other intermediate information during execution of instructions by processor 604. Computer system 600 also includes a read only memory (ROM) 608 and/or other static storage device coupled to bus 602 for storing static information and instructions for processor 604.

Further, a mass storage device 610, such as a magnetic disk drive and/or a optical disk drive, may be coupled to computer system 600 for storing information and instructions. Computer system 600 can also be coupled via bus 602 to a display device 634, such as a cathode ray tube (CRT) or a liquid crystal display (LCD), for displaying information to a user so that, for example, graphical or textual information may be presented to the user on display device 634. Typically, an alphanumeric input device 636, including alphanumeric and other keys, is coupled to bus 602 for communicating information and/or user commands to processor 604. Another type of user input device shown in the figure is a cursor control device (638, such as a conventional mouse, touch mouse, trackball, track pad or other type of cursor direction key for communicating direction information and command selection to processor 604 and for controlling movement of a cursor on display 634. Various types of input: devices, including, but not limited to the input devices described herein unless otherwise noted, allow the user to provide command or input to computer system 600. For example in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 600 may optionally include such devices as a video camera, speakers, a sound card, or many other conventional computer peripheral options.

A communication device 640 is also coupled to bus 602 for accessing other computer systems, as described below. Communication device 640 may include a modern, a network interface card, or other well-known interface devices, such as those used for interfacing with Ethernet, Token-ring, or other types of networks. In this manner, computer system 600 may be coupled to a number of other computer systems.

Those of skill in the art would understand that information and signals may be represented using any or a variety of different technologies and techniques. For example, data, instructions, commands, information, signals, bits, symbols, and chips that may be referenced throughout the above description may be represented by voltages, currents, electromagnetic waves magnetic fields or particles, optical fields or particles, or any combination thereof.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying Evans for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module ma) reside in RAM memory flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC, The ASIC may reside in a user terminal. In the alternative, the processor and the storage medium ma) reside as discrete components in a user terminal. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The teachings herein may be incorporated into (e.g., implemented within or performed by) a variety of apparatuses (e.g., devices). Accordingly, one or more aspects taught herein may be incorporated into a computer (e.g., a laptop), a phone (e.g., a cellular phone or smart phone), a portable communication device, a portable computing device (e.g., a personal data assistant), an entertainment device (e.g., a music or video device, or a satellite radio), a global positioning system device, or any other suitable device that is configured to communicate via a network medium.

The various illustrative logical blocks, modules, and circuits described in connection with the aspects disclosed herein may be implemented within or performed by an integrated circuit (“IC”), in access terminal, or in access point. The IC mars comprise a general purpose processor, a digital signal processor (DSP), an application specific integrated circuit (ASIC), a field programmable gate array (FPGA) or other programmable logic device, discrete gale or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed aspects is provided to enable any person skilled in the art to make or use the present: disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded the widest scope consistent with the principles and novel features disclosed herein.

What is claimed is:

1. A method for assisting a live agent in interacting with customer inquiries through a network chat messaging system for a website comprising:
detecting a customer interaction with the website;
determining whether an automated response system is enabled to respond to the customer interaction, the automated response system being capable of interacting with the customer through the network chat messaging system using an artificial intelligence (AI) system; and,
notifying the live agent regarding the customer interaction upon determining the automated response system is disabled.

2. The method of claim 1, further comprising responding to the customer interaction upon determining the automated response system is enabled.

3. The method of claim 1, further comprising:
receiving a response message from the live agent based on the customer interaction; and
sending the response message to the customer using the network chat messaging system.

4. The method of claim 1, wherein the detected customer interaction is comprised of at least one of a chat message from the customer, a request to initiate a chat session, and a predetermined interaction between the customer and the website.

5. The method of claim 1 wherein the AI system comprises a database and wherein the method further comprising performing a search in the database to determine a proposed response to the customer interaction.

6. The method of claim 5 further comprising:
providing the proposed response to the live agent, and
receiving a command from the live agent based on the proposed response wherein the command comprising at least one of editing the proposed response, and transmitting a live agent response based on the proposed response to the customer.

7. The method of claim 5, further comprising disabling the automatic automated response system based on a match with a predetermined condition during the search of the database.

8. The method of claim 5. Wherein the proposed response is a predetermined phrase relevant to the detected customer interaction.

9. The method of claim 1, further comprising disabling the automated response system based on a command from the live agent.

10. A computer interface for a live agent to interact with a plurality of customers through a network chat messaging system having an artificial intelligence (AI) system for interacting with each customer in the plurality of customers, the computer interface comprising:
a list of live chat sessions being monitored by the live agent the list comprising a chat session status indicator; and
a chat session interface for monitoring the AI system and interacting with at least one customer in the plurality of customers comprising:
a live agent message input field;
a live agent message display; and
an AI system proposed response display, for displaying proposed responses generated by the AI system.

11. The computer interface of claim 10 the chat session status indicator comprises at least one of an attention needed status, a fully-automated status, and a timer measuring the elapsed time of an interaction between the customer and the live agent.

12. The computer interface of claim 10, further comprising an alert system for alerting the live agent when input from the live agent is needed during an interaction with a customer.

13. The computer interface of claim 10, further comprising an AI system toggle for manipulating an operation of the AI system from a full automated response mode, wherein the AI system will interact with a customer without the intervention of the live agent, to a manual response mode, wherein the live agent will participate in an interaction with the customer.

14. The computer interface of claim 10, wherein proposed responses are generated by the AI system using a search of a database for matches based on a customer input.

15. The computer interface of claim 10, further comprising a propose response selector for allowing the live agent to select at least one of the proposed responses.

16. The computer interface of claim 10, further comprising a chat session re-pool interface for re-pooling at least one live chat session in the list of live chat sessions.

17. A computer program product for assisting a live agent in interacting with customer inquiries through a network chat messaging system for a website comprising:
a computer readable medium comprising codes executable to:
detect a customer interaction with the website;
determine whether an automated response system is enabled to respond to the customer interaction, the automated response system being capable of interacting with the customer through the network chat messaging system using an artificial intelligence (AI) system; and,
notify the live agent regarding the customer interaction upon determining the automated response system is disabled.

18. The computer program product of claim 17, wherein the computer readable medium further comprising codes executable to respond to the customer interaction upon determining the automated response system is enabled.

19. The computer program product of claim 17, wherein the computer readable medium further comprising codes executable to:
receive a response message from the live agent based on the customer interaction; and
send the response message to the customer using the network chat messaging system.

20. The computer program product of claim 17, wherein the detected customer interaction is comprised of at least one of a chat message from the customer, a request to initiate a chat session, and a predetermined interaction between the customer and the website.

21. The computer program product of claim 17, wherein the AI system comprises a database and wherein the computer readable medium further comprising codes executable to perform a search in the database to determine a proposed response to the customer interaction.

22. The computer program product of claim 21, wherein the computer readable medium further comprising codes executable to:
provide the proposed response to the live agent, and
receive a command from the live agent based on the proposed response, wherein the command comprising at least one of editing the proposed response, and transmitting a live agent response based on the proposed response to the customer.

23. The computer program product of claim 21, wherein the computer readable medium further comprising codes executable to disable the automatic automated response system based on a match with a predetermined condition during the search of the database.

24. The computer program product of claim 17, wherein the proposed response is a predetermined phrase relevant to the detected customer interaction.

25. The computer program product of claim 17, wherein the computer readable medium further comprising codes executable to disable the automated response system based on a command from the live agent.
